(19) United States
(12) Patent Application Publication
(10) Pub. No.: US 2007/0189835 A1
(43) Pub. Date: Aug. 16, 2007

(54) Packaging comprising an applicator for applying liquid and pasty media

(75) Inventors: Carsten Klocke, Karlsruhe (DE); Klaus Renner, Ettlingen (DE)

Correspondence Address: BROWDY AND NEIMARK, P.L.L.C.;624 NINTH STREET, NW, SUITE 300, WASHINGTON, DC, 20001-5303, US

(73) Assignee: Klocke Verpackungs-Service GMBH, Weingarten (DE)

(21) Appl. No.: 10/594,082

(22) PCT Filed: May 26, 2004
(86) PCT No.: PCT/DE04/01093

§ 371 Date: Sep. 25, 2006

(30) Foreign Application Priority Data
Mar. 25, 2004 (DE) 20 2004 004 857.4

(51) Int. Cl. B43K 5/14

(52) U.S. Cl. 401/133; 401/132

(57) ABSTRACT

The invention relates to a packaging comprising an applicator (1.4; 2.2; 3.2; 4.1; 5.1; 6.1; 7.1; 8.1; 9.5; 10.5) for applying liquid and pasty media. Said applicator consists of a material which is permeable to the medium (1.5; . . . ) and is connected to a receiving opening (1.6; . . . ) of the packaging (1.0; . . . ; 10.0), at least in parts of the contact surface, covering the same. The packaging and applicator thus form a unit in which the applicator is positioned above the outlet for the content of the packaging. In this way, a packaging is created in a customer-friendly manner, with a secure connection between the packaging and the applicator, that, together with the shape of the applicator, essentially influences the guiding of the product. The packaging can thus be handled safely e.g. undesired rapid discharge of the product and injuries caused by sharp edges are prevented.

### TECHNICAL BACKGROUND

Liquid and pasty media are applied in many applications by means of an applicator. On one hand, unintentional skin contact can be prevented in this manner, on the other hand an applicator permits a more uniform product-specific and application-specific application.

### DISCLOSURE OF THE INVENTION

To provide for a customer-friendly application, the present invention has as its object to create a packaging that is easy to handle. Moreover, the intent is to create a reliable connection between the packaging and applicator, since this connection in interaction with the design of the applicator considerably influences how the product is guided.

This object is met with the characteristics of claim 1.

The basic concept of the invention is thus for the packaging and applicator to form a unit in which the applicator is already positioned above the outlet location for the content of the packaging.

As a result, the packaging also provides for safe handling, e.g., protection against unintentional rapid discharge of the product and protection against injuries caused by sharp edges.

In accordance with additional characteristics according to the subclaims, the packaging, e.g., in the form of a break-off packaging, has in its dispensing region, which may be designed as a nozzle or unsealed region for guiding of the product, a predetermined break point, which upon activation, exposes a discharge opening for the medium. Fixed above the predetermined break point is a preferably absorbent applicator, e.g., of a foamed material, nonwoven fabric, or felt.

The applicator projects beyond the predetermined break point on both sides and is fixed on both sides of the predetermined break point. Its dimension in the axial direction relative to the predetermined break point may be either smaller or larger than the dimension of the packaging, or it may also terminate with the same contours as the packaging.

The applicator may be connected to the product-carrying packaging either by means of an adhesive medium or by means of a seal, in such a way that, in dependence upon the design and utilized connecting process, the connecting medium may extend on the applicator over the entire contact region between the applicator and packaging, or also only over partial regions of the contact surface.

In order to bring the product to application, all that is required is to break open the dispensing region of the packaging along the predetermined break point and to fold the end region of the packaging that extends beyond the predetermined break point, along with the applicator that is fixed on it, about the break-open axis in the radial direction. By breaking open the packaging along the predetermined break point, access to the product is uncovered, so that the applicator that is situated above it can become saturated with it and the packaging can be used for the application.

The applicator covers the region of the predetermined break point even after the opening process at least to such a degree that any risk of injuries that may be posed by it due to sharp edges is minimized. Since the product discharge opening is covered during the opening process and application, an unintentional rapid discharge of the product from the packaging is prevented as well.

### BRIEF DESCRIPTION OF THE DRAWINGS

Preferred example embodiments shall now be explained in more detail with the aid of drawings showing the following:

FIGS. 1, 2: A first example embodiment in a front view and sectional side view, as well as a section through the activated packaging,

FIG. 3: a second example embodiment in the front view,

FIG. 4: a third example embodiment in the front view,

FIGS. 5, 6: the connection point between the packaging and applicator,

FIGS. 7, 7B: an applicator with cuts for improved product dispensing,

FIG. 8: an applicator with perforations for improved product dispensing,

FIG. 9: a fourth example embodiment,

FIG. 10: a fifth example embodiment,

FIG. 11: a sixth example embodiment,

FIG. 12: a seventh example embodiment.

### DESCRIPTION OF THE EXAMPLE EMBODIMENTS

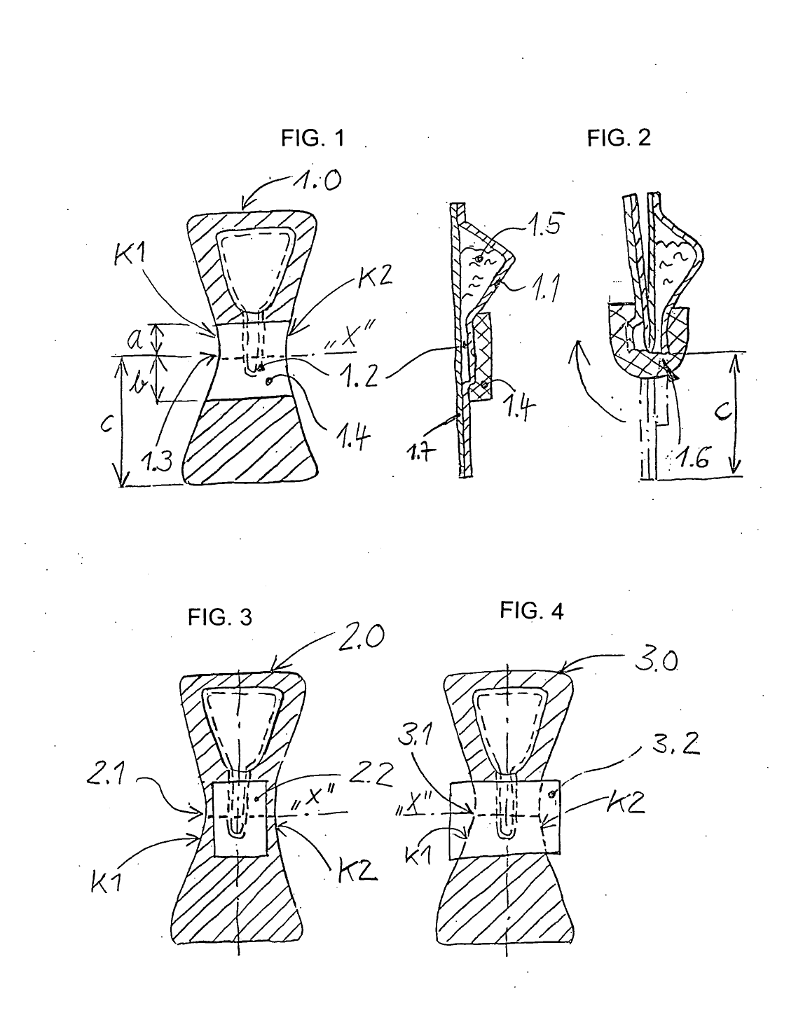

FIGS. 1 and 2 show a first example embodiment of the packaging in a front view, as well as its side view in a section.

A packaging 1.0 having a cup 1.1 sealed by a cover foil 1.7 for accommodating a liquid or pasty content is extended by a nozzle-shaped section 1.2, or by a seal-free region, for dispensing of the product. Extending at a right angle relative to the longitudinal orientation of the section 1.2 is a predetermined break point 1.3. Fixed above the predetermined break point 1.3 is an absorbent applicator 1.4 in any desired shape, which may be affixed by means of an adhesive medium or by means of a welding process. The applicator 1.4 projects in the longitudinal direction of the packaging beyond the predetermined break point 1.3 on both sides (a and b). In the depicted example embodiment, the applicator 1.4 terminates in the direction of the break-open axis -x- with the same contours (K1 and K2) as the packaging 1.0.

In order to bring the content 1.5 of the packaging 1.0 to application, the packaging 1.0 is broken open at its predetermined break point 1.3. The region -c- of the packaging 1.0 that projects beyond the predetermined break point 1.3 is now being bent, along with the partial region -b- of the applicator 1.4 that is fixed on it, about the break-open axis “x” in the direction away from the affixed applicator 1.4, so that the dispensing opening 1.6, which releases the content 1.5 of the packaging 1.0, is encompassed by the applicator 1.4 and does not pose any risk of injury. The content 1.1 of the packaging 1.0 can now penetrate into the applicator 1.4; the packaging 1.0 can then be used for applying the medium.

FIG. 3 shows a second example embodiment in the front view. The basic construction of the packaging 2.0 corresponds to that in the first example embodiment and will not be described in detail. Fixed above the predetermined break point 2.1 of the packaging 2.0 is an applicator 2.2, which is set back from the contour K1 and K2 toward the break-open axis -x- of the packaging 2.0.

The activation process corresponds to that of the packaging 1.0.

FIG. 4 shows a third example embodiment in the front view. The basic construction of the packaging 3.0 corresponds to the first example embodiment and will not be described in detail.

Fixed above the predetermined break point 3.1 of the packaging 3.0 is an applicator 3.2, which projects beyond the contour K1 and K2 of the packaging in the direction of the break-open axis -x-.

The activation process corresponds to that of packaging 1.0.

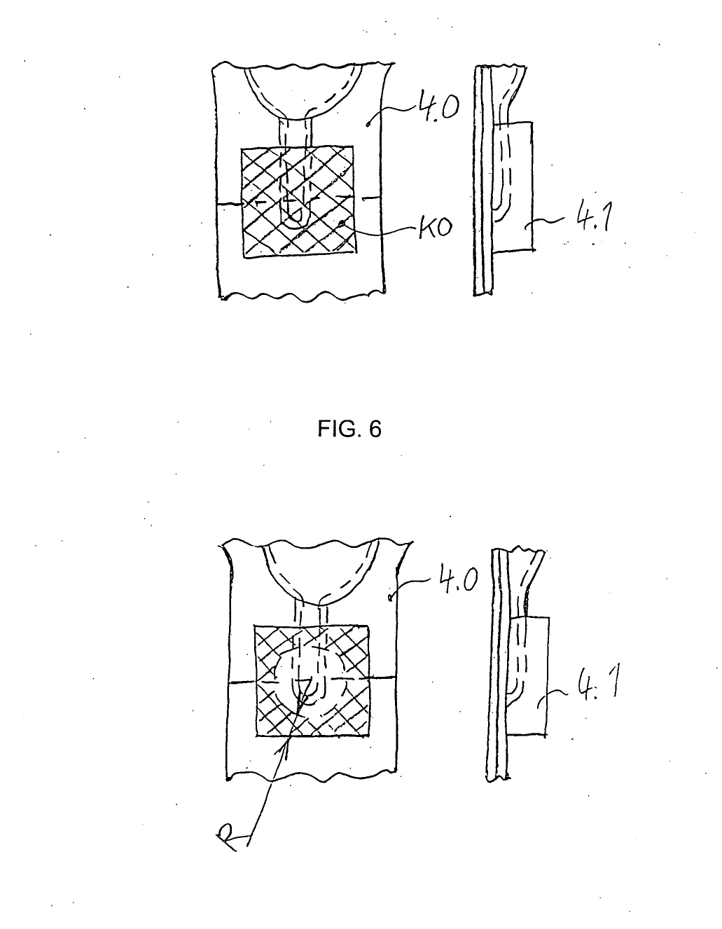

FIG. 5 and FIG. 6 show the connection point between a packaging 4.0 and an applicator 4.1. The connection point may be created either by means of an adhesive medium, or by means of a welding process and it may extend, as shown in FIG. 5, over the entire contact region KO between the packaging 4.0 and applicator 4.1 or, as illustrated in FIG. 6, as a circumferential border -R- around what will later become the discharge location for the packaged product.

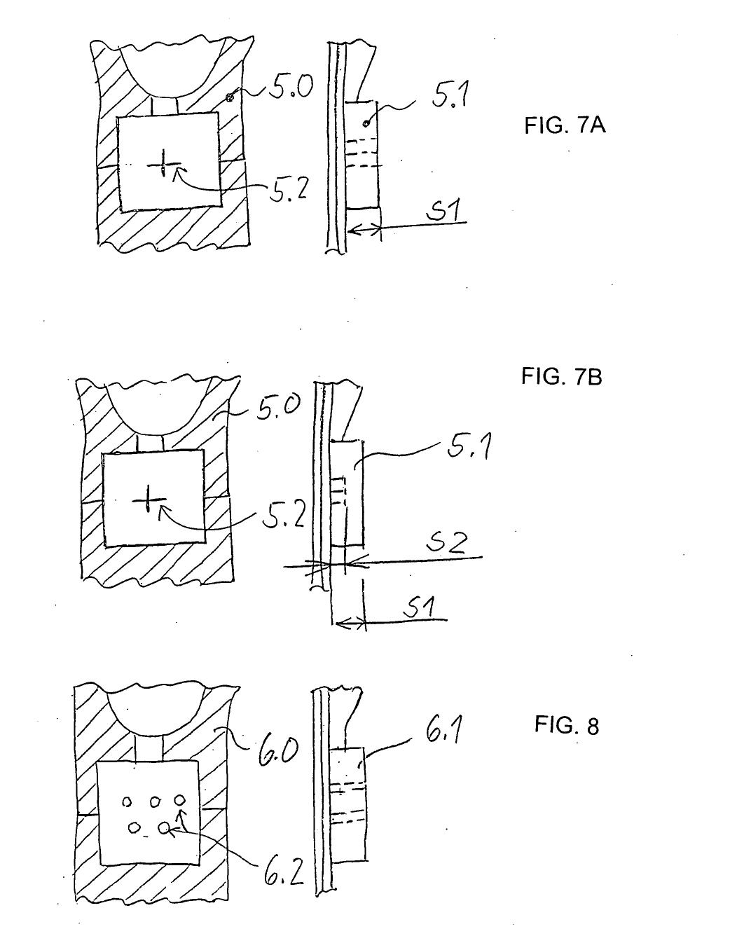

FIGS. 7A and 7B show a partial region of a packaging 5.0 with an applicator 5.1 fixed on it. The applicator 5.1 is provided, for improved product delivery, with one or multiple cuts 5.2 in any desired shape. These cuts may extend over the entire thickness S1 of the applicator 5.1 (FIG. 7A), or as shown in FIG. 7B, they may also penetrate through only a portion S2 of the thickness S1 of the applicator 5.1.

FIG. 8 shows a partial region of a packaging 6.0 with an applicator 6.1 fixed on it. The applicator is provided, for improved product delivery, with one or multiple perforations 6.2.

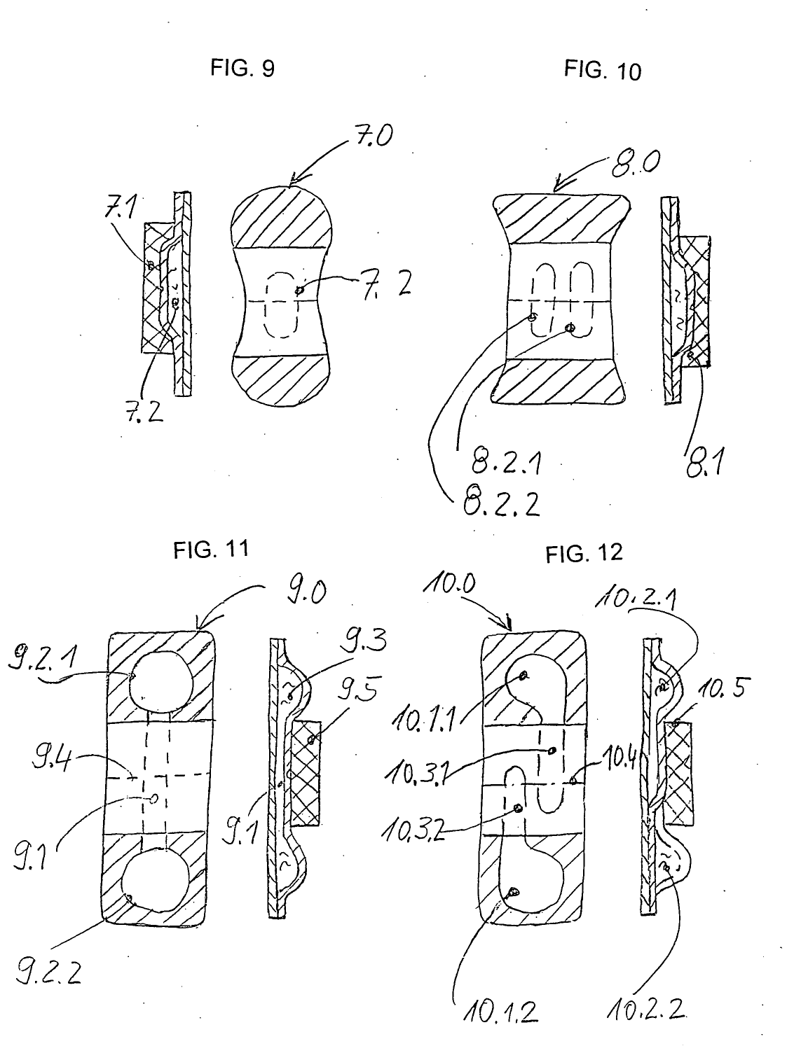

FIG. 9 shows, in a fourth example embodiment, a packaging 7.0. The basic construction corresponds to the first example embodiment and will not be described in detail. An applicator 7.1 in this case overlaps the entire region of the packaging 7.2 intended for accommodation of the product. The break-open function corresponds to that of the versions described up to now.

FIG. 10 shows, in a fifth example embodiment, a packaging 8.0. It substantially corresponds to the packaging 7.0. The applicator 8.1 in this case overlaps two regions 8.2.1 and 8.2.2 for accommodation of the product, in which different media may be accommodated.

FIG. 11 shows, in a sixth example embodiment, a packaging 9.0. The basic construction substantially corresponds to the packaging 1.0.

The nozzle or seal-free region, respectively, for discharge of the packaged product 9.1 represents a connection between two cups 9.2.1 and 9.2.2 containing the packaged product 9.3. Extending at a right angle relative to the longitudinal orientation of the nozzle-shaped section 9.1. and centrical relative to the cups 9.2.1 and 9.2.2 for accommodation of the product is a predetermined break point 9.4 above which an applicator 9.5 is fixed according to the first example embodiment.

The principle of operation corresponds to that of example embodiment 1.

FIG. 12 shows, in a seventh example embodiment, a packaging 10.0. The packaging 10.0 is provided, like the packaging 9.0, with two cups 10.1.1 and 10.1.2 for accommodating different packaged products 10.2.1 and 10.2.2. Each of the cups is extended by a nozzle-shaped section or by an unsealed region 10.3.1 or 10.3.2, respectively, for discharge of the packaged products, which extend parallel to each other. Extending centrical relative to the cups 10.1.1 and 10.1.2 and at a right angle relative to the sections 10.3.1 and 10.3.2 is the predetermined break point 10.4. The two sections 10.3.1 and 10.3.2 are arranged diametrically opposed in such a way that the predetermined break point 10.4 intersects both sections. Fixed above the predetermined break point is an applicator 10.5 in the previously described manner.

The principle of operation corresponds to that of the example embodiments described up to now.

What is claimed is:

1. A packaging comprising an applicator for applying liquid and pasty media, characterized in that the applicator (1.4; 2.2; 3.2; 4.1; 5.1; 6.1; 7.1; 8.1; 9.5; 10.5) consists of a material which is permeable to the medium (1.5; . . . ) and covers a dispensing opening (1.6; . . . ) of the packaging (1.0; . . . 10.0), to which it is connected at least in partial areas of the contact surface.

2. A packaging according to claim 1, characterized in that it is configured as a deep-drawn packaging having at least one deep-drawn cup (1.1; . . . ) and a sealed-on cover film (1.7; . . . ).

3. A packaging according to claim 1 and 2, characterized in that the dispensing opening (1.6; . . . ) is designed as a predetermined break point (1.3) of the at least one cup or of the at least one nozzle-shaped section (1.2; . . . ) of the same, to which the applicator is connected.

4. A packaging according to claim 3, characterized in that the applicator is fixed by gluing or sealing.

5. A packaging according to claim 4, characterized in that the glued or sealed region extends only over portions of the contact region between the applicator and cup, leaving free especially the predetermined break point.

6. A packaging according to claim 1, characterized in that the applicator consists of absorbent material, such as a foamed material, nonwoven fabric, or felt.

7. A packaging according to claim 3 through 5, characterized in that the predetermined break point forms a separate or common break-off tip (10.4) of the at least one cup (10.1.1; 10.1.2) or of the at least one nozzle-shaped section.

8. A packaging according to claim 1 through 3, characterized in that the applicator has, above the dispensing opening, a delivery channel extending at least partly to the outside, in the form of cuts or punchings (5.2).

9. A packaging according to claim 1 through 3, characterized in that the applicator has at least one perforation or cavity (6.2) extending at least partly from the cup to the outside.
